(19) United States
(12) Patent Application Publication
(10) Pub. No.: US 2020/0262053 A1
(43) Pub. Date: Aug. 20, 2020

(54) MOTORIZED HUMANOID ROBOT

(71) Applicant: SOFTBANK ROBOTICS EUROPE, PARIS (FR)

(72) Inventor: Vincent CLERC, CLAMART (FR)

(21) Appl. No.: 15/776,745

(22) PCT Filed: Nov. 14, 2016
(86) PCT No.: PCT/EP2016/077575

§ 371 Date: May 16, 2018

(30) Foreign Application Priority Data
Nov. 18, 2015 (FR) 1561106

(51) Int. Cl. B25J 9/00; B62D 61/00

(52) U.S. Cl. CPC B25J 9/0003; B62D 61/00

(57) ABSTRACT

A motorized humanoid robot having a positioning axis extending along a reference axis in a reference position and capable of moving on a horizontal plane, comprises a first and a second wheel in contact with the horizontal plane. The robot comprises a base having a warped surface which, in a vertical plane passing through the center of the wheels, extends on either side of each of the wheels, the warped surface being able to form, at any point of the warped surface, a first point of contact with the horizontal plane, defining, for any first point of contact, a center of rotation, and wherein the robot is configured in such a way that the center of rotation and the center of gravity of the robot are offset so as to generate a torque tending to return the robot from any position in which its positioning axis forms a non-zero angle with the reference axis to the reference position.

The invention relates to a motorized humanoid robot which can in particular be in a professional context or in a family context with the possibility of interactions with children.

A humanoid robot should be understood to be a robot exhibiting similarities with the human body. It may the top of the body, or only an articulated arm ending in a clamp that can be likened to a human hand. In the present invention, the top of the body of the robot is similar to that of a human trunk. A humanoid robot can be more or less sophisticated. It can control its own balance statically and dynamically and walk on two limbs, possibly in three dimensions, or simply roll on a base. It can collect signals from the environment (sound, sight, touch, etc.) and react according to one or more more or less sophisticated behaviors, and interact with other robots or human beings, either by speech, or by gestures. For a current generation of humanoid robots, programmers are capable of creating scenarios, more or less sophisticated, such as sequences of events for the robot and/or actions performed by the robot. These actions can be conditional on certain behaviors of people interacting with the robot.

For any mobile vehicle, and therefore also for a robot that is capable of moving, it is very important to take account of the safety of the mobile vehicle and of the elements of its environment. The safety of the robot and of the elements of its environment particularly involves avoiding dropping the robot, even if it is toppled over, in order not to damage the robot and/or any element in its environment. Similarly, it is desirable for the robot not to fall on children. It is also essential to avoid any risk of pinching on contact with the robot. For example, if a person enters into contact with the robot and even if that person interacts with certain limbs of the robot, it is essential to avoid having the person, for example a finger of the person, pinched under an arm of the robot. Finally, it is ideally desirable to address these safety criteria as inexpensively as possible.

For any motorized robot desired to be mobile there is the issue, during its design, of how to obtain the mobility. There are humanoid robots with two limbs similar to two legs. This solution is very complex to implement and involves significant costs. Furthermore, this solution is unsatisfactory from a point of view of safety since such a robot can easily be unbalanced and fall if it is toppled or turned over, and remain on the ground without necessarily having the capacity to rise up again. There are also humanoid robots whose mobility is ensured by a pedestal comprising three wheels. This solution, naturally stable in the static phases, is fairly costly and does not exclude a risk of falling during the dynamic phases since the projected center of mass can momentarily depart from the support triangle. There are also mobility solutions with a pedestal comprising two wheels facing one another based on the principles of the inverted pendulum. This solution offers the advantage of being less costly than the solution with three wheels but is absolutely not safe. Indeed, in case of failure of the control members or of the active stabilization algorithms, a robot provided with such a mobility solution can fall, be damaged and possibly injure a person situated in its environment. There are finally systems with a single point of contact on the ground, driven on three axes by ball friction (robots of ballbot type), based also on the principle of inverted pendulua. For the same reasons as in the preceding case, in case of failure of the control members or of the active stabilization algorithms, such robots provided with such a mobility solution can fall, be damaged and possible injure a person situated in their environments. The patent application FR2820985 describes an interactive mobile toy with spontaneous recovery but the configuration of its two wheels facing one another does not resolve the damping of the inpacts. Indeed, the spontaneous recovery is ensured in a front to back movement, but a lateral toppling can make it fall in which case the toy is not able to directly recover. Once tilted to the side, the toy rolls slightly so as to assume the position stretched out on its back, to allow it to recover. The result thereof is that, upon a lateral impact, the robot is unable to damp the impact. On entering into collision with an object upon a lateral impact, the object receives the effect of a blow since such a toy is not able to tilt evenly and continuously so as to minimize the forces perceived by the object.

The invention aims to overcome all or some of the problems cited above by proposing an anti-pinching motorized humanoid robot, of specific form and of a weight distribution which are such that it recovers spontaneously whatever the angle of inclination which is imposed on it and whatever the direction in which the robot is inclined.

To this end, the subject of the invention is a motorized humanoid robot having a positioning axis extending along a reference axis in a reference position and capable of moving on a horizontal plane, comprising:

a first wheel and a second wheel in contact with the horizontal plane, the first wheel having a first center and the second wheel having a second center, a motorization unit intended to rotationally drive the first and second wheels, so that the robot moves on the horizontal plane, characterized in that the robot comprises a base having a warped surface which, in a vertical plane passing through the first center of the first wheel and the second center of the second wheel, extends on either side of each of the first and second wheels, the warped surface being able to form, at any point of the warped surface, a first point of contact with the horizontal plane, defining, for any first point of contact, a center of rotation, and in that the robot is configured in such a way that the center of rotation and the center of gravity of the robot are offset so as to generate a torque tending to return the robot from any position in which its positioning axis forms a non-zero angle with the reference axis to the reference position.

According to one embodiment, the first wheel having a first rolling surface and the second wheel having a second rolling surface, the base is substantially ellipsoid of center O, the first rolling surface coincides substantially with the perimeter of a first section of the base and the second rolling surface coincides substantially with the perimeter of a second section of the base, the first and second rolling surfaces protruding from the base, so that the robot has a ground clearance greater than or equal to zero.

Advantageously, the warped surface and the rolling surfaces are configured to allow, at any point of the warped surface, a return of the robot from any position in which its positioning axis forms a non-zero angle with the reference axis to the reference position by following the shortest path on the warped surface.

According to another embodiment, the first wheel being in contact with the horizontal plane at a second point of contact and having a first outer point diametrically opposite the second point of contact and the second wheel being in contact with the horizontal plane at a third point of contact and having a second outer point diametrically opposite the third point of contact, the distance between the second and third points of contact is less than the distance between the first and second outer points.

According to another embodiment, the robot comprises a top part positioned on the base and a first articulation linking the top part to the base, and the first articulation has at least one degree of freedom in rotation about the positioning axis relative to the base.

Advantageously, the robot comprises at least one upper limb and a second articulation linking the at least one upper limb to the top part, and the second articulation has at least one degree of freedom in rotation relative to the top part.

Advantageously, the top part comprises:

a thorax, the first articulation linking the thorax to the base, a head and a third articulation linking the head to the thorax, and the third articulation has a degree of freedom in rotation about the positioning axis relative to the thorax.

Advantageously, the second articulation links the at least one upper limb to the thorax, and the second articulation has at least one degree of freedom in rotation relative to the thorax.

According to another embodiment, the motorization unit is configured to drive the first and second wheels in a differential manner.

According to another embodiment, the robot comprises a motorized counterweight intended to move the center of gravity of the robot within the base.

Advantageously, the at least one upper limb comprises a flexible zone capable of facing the base or the top part.

According to another embodiment, the robot is configured so as to translate the first wheel along an axis passing through a diameter of the first wheel and the second wheel along an axis passing through a diameter of the second wheel.

The invention will be better understood and other advantages will become apparent from reading the detailed description of an embodiment given by way of example, the description being illustrated by the attached drawing in which:

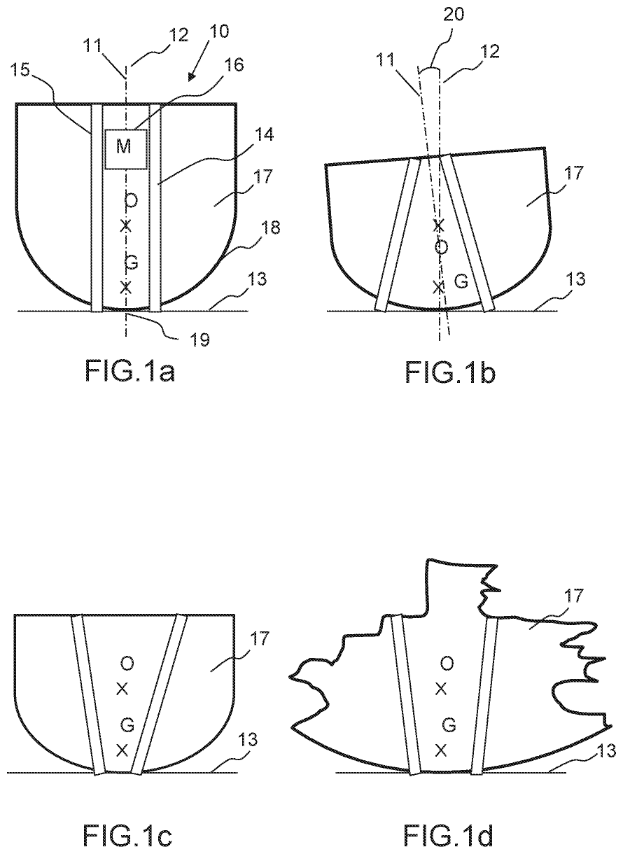

FIGS. 1a, 1b, 1c and 1d schematically represent several possible configurations of a humanoid robot according to the invention,

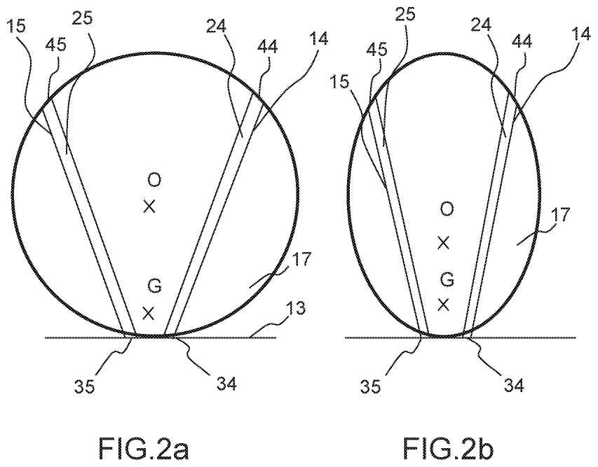

FIGS. 2a and 2b schematically represent several possible configurations of an ellipsoid base for a humanoid robot according to the invention,

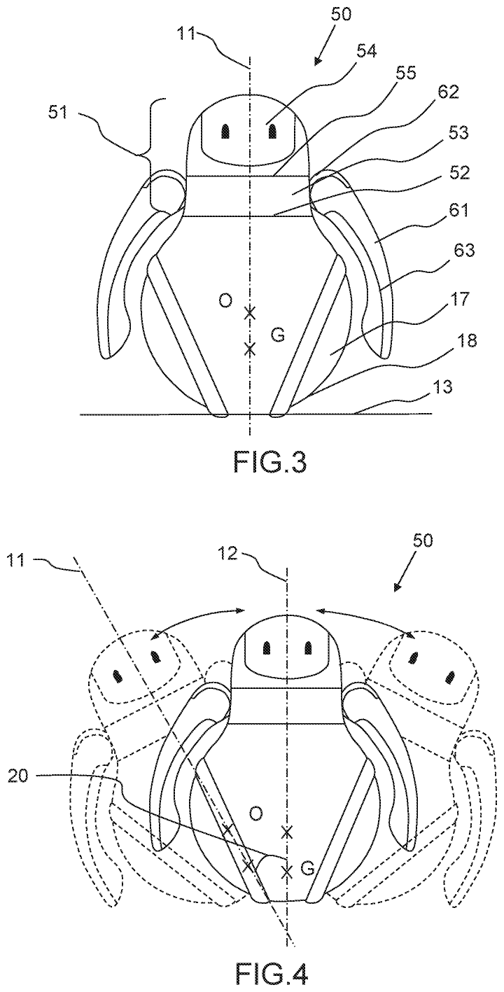

FIG. 3 represents, seen from the front, a humanoid robot according to the invention,

FIG. 4 schematically represents lateral movements of the humanoid robot according to the invention,

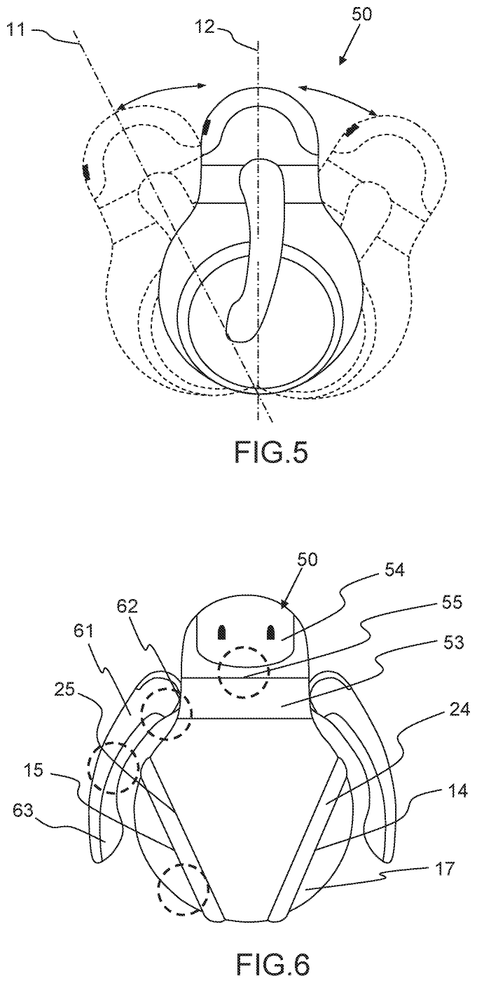

FIG. 5 schematically represents front to back movements of the humanoid robot according to the invention,

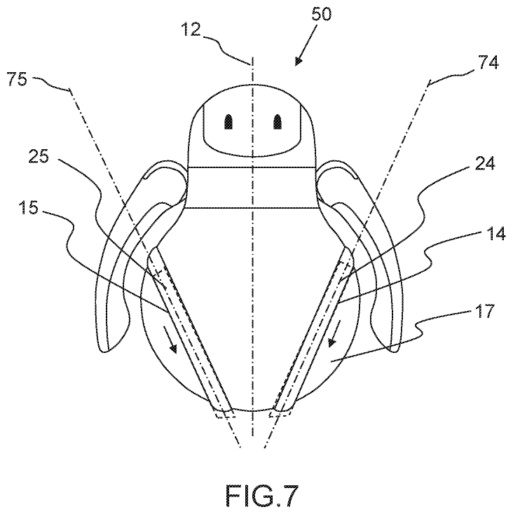

FIG. 6 highlights the anti-pinching features of the humanoid robot according to the invention in zones prone to pinching,

FIG. 7 illustrates the capacity of the humanoid robot according to the invention to vary its ground clearance.

In the interests of clarity, the same elements will bear the same references in the different figures.

FIGS. 1a, 1b, 1c and 1d schematically represent several possible configurations of a humanoid robot according to the invention. The humanoid robot 10 is motorized and has a positioning axis 11 extending along a reference axis 12 in a reference position as represented in FIG. 1a. The robot 10 is able to move on a horizontal plane 13 and it comprises a first wheel 14 and a second wheel 15 in contact with the horizontal plane 13, the first wheel 14 having a first center and the second wheel 15 having a second center, a motorization unit 16 intended to rotationally drive the first and second wheels 14, 15 so that the robot moves on the horizontal plane. According to the invention, the robot 10 comprises a base 17 having a warped surface 18 which, in a vertical plane passing through the first center of the first wheel 14 and the second center of the second wheel 15, extends on either side of each of the first and second wheels 14, 15, the warped surface 18 being able to form, at any point of the warped surface, a first point of contact 19 with the horizontal plane 13, defining, for any first point of contact 19, a center of rotation O, and the robot 10 is configured in such a way that the center of rotation O and the center of gravity G of the robot 10 are offset so as to generate a torque tending to return the robot 10 from any position around the base 17 in which its positioning axis 11 forms a non-zero angle 20 with the reference axis 12 (as illustrated in FIG. 1b) directly to the reference position, the positioning axis 11 sweeping the angle 20 until it coincides with the reference axis 12. In other words, the robot 10 can be inclined such that its positioning axis 11 is in a cone whose vertex is the point of contact between the base 17 and the horizontal plane 13 and whose cone base is parallel to the horizontal plane 13. The angle 20 between the positioning axis 11 and the reference axis 12 can lie between 0° and 90°, within the limit possible according to the form of the base 17. The positioning axis 11 of the robot 10 can be inclined for example by 45° relative to the reference axis 12.

In other words, the positioning axis 11 and the reference axis 12 form a plane and the torque generated tends to return the robot 10 from any possible position at 360° around the base 17 to the reference position 12, the positioning axis 11 being moved in the plane formed by the two axes until it coincides with the reference axis 12.

Thus, when the robot 10 has been inclined, the reaction of the horizontal plane 13 and of the weight of the robot form a torque which returns the robot 10 into its reference position. This torque depends on the distance between the center of rotation O and the center of gravity G of the robot 10, the center of gravity G being always situated between the horizontal plane 13 and the plane parallel to the horizontal plane 13 containing the center of rotation O. Also, this torque allows the robot 10 a spontaneous recovery of the robot, whatever the angle of inclination which has been imposed on it and whatever the direction in which the robot 10 has been inclined. This recovery, or return to the stable position of equilibrium, is due solely to the action of gravity applied to the physics of solids and is in no case active or the result of a mechanical action driven by an algorithm, and therefore takes place without electronic or computing intervention, rendering the platform intrinsically stable.

As represented in FIGS. 1a, 1b, 1c, the wheels 14, 15 can be parallel to one another or not. FIG. 1d illustrates the fact that the base 17 can have any form. One condition necessary to the invention is that the base 17 has a warped surface 18 forming a point of contact 19 with the horizontal plane 13 and that the distance between the center of rotation of the base 17 at this point of contact 19 and the center of gravity G of the robot 10 is such that a return torque is formed, that is to say a torque tending to return the robot 10 from any position into its reference position. The result thereof is that the robot 10 can be toppled for example forward or backward, but also laterally in any direction. In this case, the robot 10 is in the so-called tilted position. In other words, its positioning axis 11 forms a non-zero angle 20 with the vertical axis 12 and the torque generated by virtue of the offset between the center of gravity G of the robot 10 and of the center of rotation O locally relative to the point of contact 19 tends to return the robot 10 to the reference position, that is to say the positioning axis 11 coinciding with the reference axis 12.

It should be noted that the reference axis 12 is represented as being the axis perpendicular to the horizontal plane 13. The invention applies also for any reference axis 12 not perpendicular to the horizontal plane 13. Indeed, depending on the configuration of the robot 10, it is perfectly possible to position the center of gravity G of the robot 10 in such a way that the robot 10 is in the inclined position relative to the vertical in the reference position. This effect can be obtained for example through the form of the robot 10 and/or by adding a counterweight in the base 17 of the robot 10. Said counterweight can advantageously be motorized in the space to dynamically change the inclination of the reference axis.

It should also be noted that while the description talks of movement of the robot 10 on a horizontal plane 13, the robot 10 is capable of moving on any plane, horizontal or inclined.

FIGS. 2a and 2b schematically represent several possible configurations of an ellipsoid base 17 for a humanoid robot according to the invention. The first wheel 14 has a first rolling surface 24 and the second wheel 15 has a second rolling surface 25. In FIGS. 2a and 2b, the base 17 is substantially ellipsoid of center O. The first rolling surface 24 coincides substantially with the perimeter of a first section of the base 17 and the second rolling surface 25 coincides substantially with the perimeter of a second section of the base 17, the first and second rolling surfaces 24, 25 protruding from the base 17, such that the robot has a ground clearance greater than or equal to zero. The substantially ellipsoid base 17 includes any base having a surface of revolution like an ovoid, but also like a spheroid. Such a base 17 offers the advantage of allowing the robot 10 to have, in all the directions and whatever the angle that its positioning axis 11 forms with the reference axis 12, a point of contact 19 with the horizontal plane 13, and a center of rotation O associated with this point of contact, and such that the center of rotation O and the center of gravity G of the robot 10 are offset so as to generate a torque tending to return the robot 10 from this position to the reference position. It can clearly be seen that the angle between its positioning axis 11 and the reference axis 12 can reach 90° and that the robot according to the invention having such a base recovers spontaneously because of the offset between the points O and G. Similarly, if the angle between its positioning axis 11 and the reference axis 12 exceeds 90°, the return to the stable position of equilibrium remains possible as long as the rolling surface remains ellipsoid or spheroid.

The fact that the first rolling surface 24 coincides substantially with the perimeter of a first section of the base 17 means that the outer surface of the first wheel 14 is substantially the same as the surface of the base 17 at this point of the base 17. More specifically, the rolling surface 24 is in the continuity of the surface of the base 17 on the top part of the base 17, as represented in FIG. 2a. In other words, there is no open space between the rolling surface 24 and the base 17, in the interests of safety, for example to avoid any pinching of a finger between the wheel 14 and the base 17. The same applies for the wheel 15 and the rolling surface 25. In the bottom part of the base 17, the rolling surface 24, just like the rolling surface 25, extends substantially from the outline of the base 17 in order to ensure a certain ground clearance for the robot 10. The rolling surfaces 24 and 25 must therefore extend from the bottom part of the base 17 to ensure an appropriate ground clearance, that is to say corresponding to the curvature of the bottom part of the base 17 between the two wheels 14, 15. Moreover, it is shrewd practice for the rolling surfaces 24 and 25 not to extend too far from the bottom part of the base 17 in order for the robot 10 not to lose its natural stability. Indeed, if the robot 10 has wheels 14, 15 whose rolling surfaces 24, 25 extend too clearly from the bottom part of the base 17, a simple lateral impact can make it fall without the possibility of reverting to its reference position. Furthermore, the wheels 14, 15 and the rolling surfaces 24, 25 are advantageously configured so as not to prevent the spontaneous recovery of the robot 10. The warped surface 18 and the rolling surfaces 24, 25 are configured to allow, at any point of the warped surface 18, a return of the robot 10 from any position in which its positioning axis 11 forms a non-zero angle 20 with the reference axis 12 to the reference position by following the shortest path on the warped surface 18. In other words, whatever the angle 20, in all the directions, to 360° around the reference axis 11, the robot 10 can spontaneously recover from its tilted position to its reference position. Even after a lateral impact, the robot 10 recovers directly following the shortest path on the warped surface 18 by exceeding the protuberance of the wheel 14 or 15.

Since the rolling surfaces 24, 25 extend from the bottom part of the base 17 and they are, at all points, outside the outline of the base 17, they can also ensure the role of damper in case of impact with an element of its environment. For example, if the robot 10 is directed toward a wall, the rolling surfaces 24, 25 come first into contact with the wall and ensure the bumper function. Similarly, these rolling surfaces 24 and 25 entering first into contact with a tread, make it possible to climb the tread. These surfaces can then be sculpted in order to improve the capacity for adherence on the edge of the tread and therefore the traversing capability of the robot.

The first wheel 14 is in contact with the horizontal plane 13 at a second point of contact 34 and has a first outer point 44 diametrically opposite the second point of contact 34 and the second wheel 15 is in contact with the horizontal plane 13 at a third point of contact 35 and has a second outer point 45 diametrically opposite the third point of contact 35. Here, wheels of circular form are considered. The invention applies also to the case of wheels of elliptical form in which case the diameter should be understood to be one of the axes of the ellipse and the diametrically opposite points should be understood to be the two points situated on the wheel each at one end of one of its axes.

Advantageously, the distance between the second and third points of contact 34, 35 is less than the distance between the first and second outer points 44, 45. As shown in FIG. 1b, the invention applies also to the case where the distance between the second and third points of contact 34, 35 is greater than the distance between the first and second outer points 44, 45. Nevertheless, the fact that the distance between the second and third points of contact 34, 35 is less than the distance between the first and second outer points 44, 45 guarantees a return to the reference position after a toppling of the robot 10 whatever the direction: front, rear or to the side.

FIG. 3 represents, seen from the front, a humanoid robot 50 according to the invention. The motorized humanoid robot 50 comprises a top part 51 positioned on the base 17 and a first articulation 52 linking the top part 51 to the base 17. The first articulation 52 has at least one degree of freedom in rotation about the positioning axis 11 relative to the base 17.

The motorized humanoid robot 50 according to the invention comprises at least one upper limb 61 and a second articulation 62 linking the upper limb 61 to the top part 51. The second articulation 62 has at least one degree of freedom in rotation relative to the top part 51. The second articulation 62 can allow the upper limb 61, that can be likened to an arm, to be set in motion from a substantially vertical position along the base 17 to a substantially vertical position, arm extended forward or backward, or to a vertical position, arm extended upward. The second articulation 62 can also allow the upper limb 61 to be rotationally mobile relative to the top part 51, the upper limb 61 extending away from the base 17 in a plane containing the positioning axis 11 and the upper limb 61. The second articulation 62 can have several degrees of freedom in rotation relative to the top part 51, in which case the upper limb 61 is able to be set in motion according to a combination of several rotations.

The robot 50 according to the invention can comprise a second upper limb, or even several others. The presence of two upper limbs contributes more to the humanoid nature of the robot 50.

The top part 51 can comprise a thorax 53. In this case, the first articulation 52 links the thorax 53 to the base 17, in such a way that the thorax is rotationally mobile about the positioning axis 11 relative to the base 17. The top part 51 can also comprise a head 54. In this case, a third articulation 55 links the head 54 to the thorax 53, and the third articulation 55 has a degree of freedom in rotation about the positioning axis 11 relative to the thorax 53. Thus, the head 54 is rotationally mobile about the positioning axis 11 relative to the thorax 53, which is itself rotationally mobile about the positioning axis 11 relative to the base 17.

The second articulation 62 can link the upper limb 61 to the thorax 53, and have at least one degree of freedom in rotation relative to the thorax 53. This configuration can for example allow the robot 50, when it moves around using its wheels 14, 15 driven by the motorization unit 16, to rotate its thorax 53 so that its upper limb 61 (or its upper limbs if there are two thereof, one on each side of the thorax 53) to be positioned in front of it along the base 17 (and behind it along the base 17 for the second upper limb) in order to reduce its lateral bulk and allow the robot 50 to be able to pass between two elements of its environment spaced apart by a distance lying between the width of its base 17 and the overall width of the robot 50, upper limb(s) included.

The upper limb 61 can comprise a flexible zone 63 that can be facing the base 17 or the top part 51. The flexible zone 63 has an anti-pinching role. Indeed, if an object or a body part of a human being is located between the upper limb 61 and the base 17 and/or the top part 51 and the upper limb 61 moves closer to the base 17 and/or the top part 51, the flexible zone 63 is deformed to avoid the pinching or the crushing of the object or of the body part.

In the case of a robot 50 with at least two upper limbs 61, the flexible zone 63 on each of the upper limbs can have a gripping role. For example, the robot 50 is capable of placing its two upper limbs 61 in front of it because of the degree of freedom of the second articulations 62, as explained previously. By bringing its two upper limbs 61 closer to one another, the flexible zone 63 of one facing the flexible zone 63 of the other, an object can be positioned between the two upper limbs 61 and held by pressure of the two upper limbs 61, the flexible zones 63 being deformed on contact with the object without damaging it.

The motorization unit 16 can be configured to drive the first and second wheels 14, 15 differentially. It can for example comprise a set of pinions or a differential gear to allow the two wheels 14, 15 to rotate at a different speed, or else two motors, each associated with one wheel, coupled to a computer making it possible to control the two motors as a function of the desired trajectories of the robot. The differential driving of the two wheels 14, 15 thus allows the robot to have movements which are not necessarily linear. It is also possible for it to revolve around itself, by having one of the two wheels turn and not the other, or to rotate on itself by having its two wheels rotate in opposite directions.

Moreover, the motorized humanoid robot according to the invention can comprise a motorized counterweight intended to move the center of gravity G of the robot 50 within the base 17. The counterweight can assume different positions using a motor, which can possibly be a motor of the motorization unit 16. Depending on the position of the counterweight, the center of gravity G of the robot 50 can change position in the base 17. This can result in a change in the reference position of the robot. For example, a robot 50 having a vertical reference axis can have a reference axis inclined by several degrees relative to the vertical after the movement of the motorized counterweight, and vice versa. The possibility of movement of the center of gravity of the robot is in particular advantageous when the robot grasps an object between its two upper limbs 61 as explained previously. For example, by grasping a water bottle, because of the weight of the water bottle, the robot, for example initially in the vertical reference position, will naturally be inclined. In other words, its positioning axis then forms a non-zero angle with its reference axis. By virtue of the motorized counterweight, the center of gravity of the robot is moved within the base 17 and the positioning axis 11 of the robot with the water bottle can then be repositioned so as to coincide with its initial reference axis.

FIG. 4 schematically represents possible lateral movements of the humanoid robot 50 according to the invention. The robot 50 being configured so that the center of rotation O and the center of gravity G of the robot 50 are offset so as to generate a torque tending to return the robot 50 from a position in which its positioning axis 11 forms a non-zero angle 20 with the reference axis 12 to the reference position. In FIGS. 4 and 5, at a given instant, the robot 50 is in a position in which its positioning axis 11 forms a non-zero angle 20 with the reference axis 12, for example following a force which has been applied to it laterally. The offset between points O and G will cause a return torque to be generated to return the robot 50 to its reference position, that is to say to return its positioning axis 11 along the reference axis 12. In this returning to the reference position, the robot 50 may oscillate about the reference axis 12, until it is in the position of balance, its positioning axis 11 coinciding with its reference axis 12.

FIG. 5 schematically represents possible forward and backward movements of the humanoid robot 50 according to the invention, similarly to the lateral movements of the robot 50 of FIG. 4. It is important to note that, by virtue of the warped surface 18 of the base forming, at any point of the warped surface 18, a first point of contact 19 with the horizontal plane 13, and by virtue of the substantially ellipsoid base 17 containing the outline of the wheels 14, 15, the motorized robot 50 can have this reciprocating movement laterally, from front to back but also in any direction around the robot 50. The maximum possible amplitude, that is to say the maximum angle between the positioning axis 11 and the reference axis 12, can reach a value of 180°, provided that the form of the base 17 permits it.

FIG. 6 highlights the anti-pinching features of the humanoid robot 50 according to the invention in zones prone to pinching. As already mentioned, the first rolling surface 24 coincides substantially with the perimeter of a first section of the base 17, which means that the outer surface of the first wheel 14 is substantially the same as the surface of the base 17 at this point of the base 17. More specifically, the rolling surface 24 is in the continuity of the surface of the base 17 on the top part of the base 17. There is therefore no open space between the rolling surface 24 and the base 17, in the interests of safety, particularly to avoid any pinching of a finger between the wheel 14 and the base 17. The same applies for the wheel 15 and the rolling surface 25.

The third articulation 55 linking the head 54 to the thorax 53 is advantageously positioned in the robot 50. The head 54 and the thorax 53 each have a contact surface complementing one another, so that no space is present between the head 54 and the thorax 53. Thus, the head 54 is rotationally mobile relative to the thorax 53 without the risk of pinching of a finger or of an object of small size between the head 54 and the thorax 53.

Similarly, the second articulation 62 linking the upper limb 61 to the top part 51 (at the level of the thorax 53 in FIG. 6) allows the upper limb 61 to be rotationally mobile relative to the thorax 53 while avoiding any risk of pinching at the second articulation 62.

Finally, the flexible zone 63 facing the base 17 or the top part 51 has an anti-pinching role. Any object or body part of a human being positioned between the upper limb 61 and the base 17 (and/or the top part 51 if the upper limb is in the raised position) can risk, without the presence of the flexible zone 63, being crushed or pinched if the upper limb 61 moves closer to the base 17 (and/or the top part 51 if the upper limb is in the raised position). Since the zone 63 is flexible, in the case where the upper limb 61 moves closer against the base 17, the flexible zone 63 is deformed to avoid the pinching or the crushing of the object or of the body part.

FIG. 7 illustrates the capacity of the humanoid robot 50 according to the invention to vary its ground clearance. In the bottom part of the base 17, the rolling surface 24, just like the rolling surface 25, extends substantially from the outline of the base 17 in order to ensure a certain ground clearance for the robot 10. The rolling surfaces 24 and 25 must therefore extend from the bottom part of the base 17 to ensure a suitable ground clearance, that is to say corresponding to the curvature of the bottom part of the base 17 between the two wheels 14, 15. As represented in FIG. 7, the motorized humanoid robot 50 according to the invention can be configured in such a way as to be able to translate the first wheel 14 along an axis 74 passing through a diameter of the first wheel 14 and the second wheel 15 along an axis 75 passing through a diameter of the second wheel 15. By thus translating the wheels 14 and 15, the ground clearance of the robot 50 is increased. This configuration can allow the robot 50 to cross an obstacle of small size by moving over it, without the base 17 entering into contact with the obstacle. More generally, this configuration allows the robot 50 to move around on any type of terrain, notably outside on a lawn or a terrace whose covering is not perfectly uniform. The capacity of the robot 50 to translate its wheels 14, 15 can allow it to cross obstacles of stair tread type. In effect, it is generally considered that a non-smooth wheel can cross, heightwise, up to half its diameter by adhesion. By translating the wheels 14, 15, substantially forward, only the wheels 14, 15 enter into contact with the tread, and the robot can cross the tread without the base 17 touching the stair tread. Moreover, by shrewdly choosing the covering of the rolling surfaces 24, 25, the robot can move around easily on any terrain. It is even possible to envisage sculpted rolling surfaces 24, 25, of crampon type, to increase the adhesion of the robot in its movements. This is particularly advantageous for outdoor use (terrace, lawn, path) of the robot 50 but also for an indoor use, for example in a space in which there are differences of levels or of floor roughness.

Finally, by translating the wheels 14, 15, it is possible to translate the robot 50 along its reference axis 12. The result thereof is that the robot 50 is raised or lowered. This translation of the wheels 14, 15 can be obtained by offsetting the center of rotation of the wheels 14, 15. The offsetting of the center of rotation of the wheels 14, 15 can be done by means of a motor, that can be included in the motorization unit 16 and by the use of cams, for example.

Moreover, it is perfectly possible to envisage providing for a scenario in which the wheels 14, 15 are translated so as to increase the ground clearance of the robot when the latter is mobile in order to facilitate the movement of the robot. Similarly, it is possible provide for, in the event of an impact, the wheels 14, 15 to be translated, that is to say retracted, so as to reduce, or even cancel, the ground clearance of the robot, so that the robot can tilt on its warped surface 18 in order to spontaneously recover and revert to its reference position without involving contact of the wheels on the ground.

The wheels 14 and 15 can also be translated independently of one another so as to provoke an inclination to the side and translated simultaneously, increasing the expressivity of the robot which can then waddle from one wheel to the other or give the impression of settling down or of rising up on its supports.

1. A motorized humanoid robot having a positioning axis extending along a reference axis in a reference position and capable of moving on a horizontal plane comprising:
a first wheel and a second wheel, in contact with the horizontal plane, the first wheel having a first center and the second wheel having a second center,
a motorization unit intended to rotationally drive the first and second wheels, so that the robot moves on the horizontal plane,
wherein the robot comprises a base having a warped surface which, in a vertical plane passing through the first center of the first wheel and the second center of the second wheel, extends on either side of each of the first and second wheels, the warped surface being able to form, at any point of the warped surface, a first point of contact with the horizontal plane defining, for any first point of contact, a center of rotation, and wherein the robot is configured in such a way that the center of rotation and the center of gravity of the robot are offset so as to generate a torque tending to return the robot from any position around the base in which its positioning axis forms a non-zero angle with the reference axis directly to the reference position, the positioning axis sweeping the angle until it coincides with the reference axis.

2. The motorized humanoid robot as claimed in claim 1, the first wheel having a first rolling surface and the second wheel having a second rolling surface, wherein the base is substantially ellipsoid of center O, and wherein the first rolling surface coincides substantially with the perimeter of a first section of the base and the second rolling surface coincides substantially with the perimeter of a second section of the base, the first and second rolling surfaces protruding from the base, so that the robot has a ground clearance greater than or equal to zero.

3. The motorized humanoid robot as claimed in claim 2, wherein the warped surface and the rolling surfaces are configured to allow, at any point of the warped surface, a return of the robot from any position in which its positioning axis forms a non-zero angle with the reference axis to the reference position by following the shortest path on the warped surface.

4. The motorized humanoid robot as claimed in claim 1, the first wheel being in contact with the horizontal plane at a second point of contact and having a first outer point diametrically opposite the second point of contact and the second wheel being in contact with the horizontal plane at a third point of contact and having a second outer point diametrically opposite the third point of contact, wherein the distance between the second and third points of contact is less than the distance between the first and second outer points.

5. The motorized humanoid robot as claimed in claim 1, comprising a top part positioned on the base and a first articulation linking the top part to the base, and wherein the first articulation has at least one degree of freedom in rotation about the positioning axis relative to the base.

6. The motorized humanoid robot as claimed in claim 5, comprising at least one upper limb and a second articulation linking the at least one upper limb to the top part, and wherein the second articulation has at least one degree of freedom in rotation relative to the top part.

7. The motorized humanoid robot as claimed in claim 5, wherein the top part comprises:
a thorax the first articulation linking the thorax to the base,
a head and a third articulation linking the head to the thorax and wherein the third articulation has a degree of freedom in rotation about the positioning axis relative to the thorax.

8. The motorized humanoid robot as claimed in claim 7 wherein the second articulation links the at least one upper limb to the thorax, and wherein the second articulation has at least one degree of freedom in rotation relative to the thorax.

9. The motorized humanoid robot as claimed in claim 1, wherein the motorization unit is configured to drive the first and second wheels in a differential manner.

10. The motorized humanoid robot as claimed in claim 1, comprising a motorized counterweight intended to move the center of gravity of the robot within the base.

11. The motorized humanoid robot as claimed in claim 6, wherein the at least one upper limb comprises a flexible zone capable of facing the base or the top part.

12. The motorized humanoid robot as claimed in claim 1, wherein it is configured so as to translate the first wheel along an axis passing through a diameter of the first wheel and the second wheel along an axis passing through a diameter of the second wheel.
